(19) United States
(12) Patent Application Publication
(10) Pub. No.: US 2009/0263154 A1
(43) Pub. Date: Oct. 22, 2009

(54) CLEANING DEVICE AND IMAGE FORMING APPARATUS USING THE SAME

(76) Inventors: Hideshi IZUMI, Ikoma-shi (JP); Toshiki TAKIGUCHI, Yamatokoriyama-shi (JP); Takahiko YOSHIDA, Nara-shi (JP)

Correspondence Address: NIXON & VANDERHYE, PC, 901 NORTH GLEBE ROAD, 11TH FLOOR, ARLINGTON, VA, 22203, US

(21) Appl. No.: 12/413,719

(22) Filed: Mar. 30, 2009

(30) Foreign Application Priority Data
Apr. 18, 2008 (JP) 2008-108933

(51) Int. Cl. G03G 15/16

(52) U.S. Cl. 399/101

(57) ABSTRACT

An intermediate transfer belt cleaning unit includes a cleaning blade put in sliding contact with the surface of a circulating intermediate transfer belt and a blade holder for holding the blade, the cleaning blade having a length extending across the width of the intermediate transfer belt, the blade holder being formed along the full length of the cleaning blade, for cleaning the surface of the intermediate transfer belt by means of the cleaning blade. In this cleaning unit, the contact pressure of the cleaning blade against the intermediate transfer belt is adjusted so that the contact pressure around both the side edges of the intermediate transfer belt is higher than the contact pressure in the remaining part.

This Nonprovisional application claims priority under 35 U.S.C. §119(a) on Patent Application No. 2008-108933 filed in Japan on 18 Apr. 2008, the entire contents of which are hereby incorporated by reference.

### BACKGROUND OF THE INVENTION

(1) Field of the Invention

The present invention relates to a cleaning device and an image forming apparatus using the cleaning device, in particular, relating to a cleaning device for cleaning the surface of an endless belt that is circulatively conveyed, as well as to an image forming apparatus using this device.

(2) Description of the Prior Art

Conventionally, color image forming apparatuses such as copiers, printers, facsimile machines and the like, include a transfer device for transferring a color toner image formed by the image forming portions, to recording paper. As one of known transfer mechanisms of such a transfer device there is an intermediate transfer system in which toner images of different colors formed at the image forming units corresponding to each color are successively transferred to an intermediate transfer element so that each toner image is laid over the others (primary transfer) and the thus layered color toner image is transferred onto recording paper by a single transfer step (second transfer).

As an example of such a transfer device, there has been a known configuration in which an endless belt, called an intermediate transfer belt, is adopted as the intermediate transfer element and this endless belt is supported on a plurality of supporting rollers so as to circulatively travel.

When this transfer mechanism is adopted, there occurs a problem that “fogging toner” that is caused by residual potential other than the toner image, transfers to the intermediate transfer belt, causing stain on the intermediate transfer belt. As a result, the intermediate transfer belt needs a cleaning device.

For this cleaning device, typically, a blade-like cleaning member is put in sliding contact with the surface of the intermediate transfer belt to remove residual toner from the surface of the intermediate transfer belt. As a prior art example, there is a proposal of a cleaning device which includes a blade-like member that is put in contact with the surface of an intermediate transfer belt and in which the contact pressure of the blade-like member against the intermediate transfer belt along its width is specified so as to be smaller at both side ends of the intermediate transfer belt than in the central part thereof (see patent document 1: Japanese Patent Application Laid-open 2001-142307). The disclosure teaches that this arrangement makes it possible to prevent the blade-like member from being turned up or rolled up and hence maintain a good cleaning condition.

In recent image forming apparatuses, there are known configurations in which, in order to prevent the intermediate transfer belt in the transfer device from meandering, a pair of guide parts (beads) 166 are formed at both side ends 161a and 161b of the intermediate transfer belt 161 so as to convey the belt along a backup roller (conveying roller) 163, as shown in FIG. 1.

However, this configuration has suffered from the problem that, as shown in FIG. 2, end part 61a of intermediate transfer belt 161 is flexed due to influence from guide part 166, producing a gap ‘t’ between intermediate transfer belt 161 and backup roller 163 against which cleaning member 165a is abutted, hence forming distortion on the intermediate transfer belt 161 surface. As a result, the surface of intermediate transfer belt 161 is warped irregularly, hence there occurs the problem that residual toner, as weaving through the cleaning blade, fails to be cleaned correctly when the surface of intermediate transfer belt 161 is tried to be uniformly cleaned by cleaning member 165a.

### SUMMARY OF THE INVENTION

The present invention has been devised in view of the above conventional problems, it is therefore an object of the present invention to provide a cleaning device which can clean the surface of a conveyed endless belt uniformly so as to prevent cleaning failure around the side edges of the endless belt, as well as to provide an image forming apparatus using this cleaning device.

In order to achieve the above object, the cleaning device according to the present invention and the image forming apparatus using the device are configured as follows:

The first aspect of the present invention resides in a cleaning device for cleaning the surface of an endless belt by means of a cleaning member, comprising: an endless belt supported and tensioned between a plurality of supporting rollers so as to circulate as the supporting rollers rotate; a cleaning member being put in sliding contact with the surface of the endless belt; and a holding member for holding the cleaning member and being characterized in that the cleaning member has a length extending across the width of the endless belt, the holding member is formed along the full length of the cleaning member, and the contact pressure of the cleaning member against the endless belt along the width of the endless belt is adjusted so that the first contact pressure around both the side edges of the endless belt is higher than the second contact pressure in the remaining part.

The second aspect of the present invention resides in a cleaning device for cleaning the surface of an endless belt by means of a cleaning member, comprising: an endless belt supported and tensioned between a plurality of supporting rollers so as to circulate as the supporting rollers rotate; a cleaning member being put in sliding contact with the surface of the endless belt; and a holding member for holding the cleaning member, and being characterized in that the cleaning member has a length extending across the width of the endless belt, the holding member has two first supports along the width of the endless belt and a second support between the two first supports, and the first distance between the first support and the endless belt is smaller than the second distance between the second support and the endless belt.

That is, the holding member is formed so that its parts around the side edges of the endless belt are formed longer toward the endless belt than the remaining part is.

According to the third aspect of the present invention, the cleaning device is characterized in that, with the cleaning member attached to the holding member, the first supports hold first cleaning portions of the cleaning member, the second support holds a second cleaning portion of the cleaning member, the length of the first cleaning portion in a first direction perpendicular to the width direction is the first length, the length of the second cleaning portion in the first direction is the second length, and, the first length is shorter than the second length.

According to the fourth aspect of the present invention, the cleaning device is characterized in that the rigidity of the first cleaning portion is higher than the rigidity of the second cleaning portion.

The fifth aspect of the present invention resides in an image forming apparatus which, based on electrophotography, produces a printout by forming a toner image on the surface of a photoreceptor drum and transferring the toner image onto a recording medium, comprising: a photoreceptor drum for forming an electrostatic latent image and a toner image based on the electrostatic latent image; a developing unit including a developing roller for supplying toner to the photoreceptor drum; a transfer device, including an endless belt as an intermediate transfer medium for temporarily supporting the toner image formed on the photoreceptor drum, and transferring the toner image to a recording medium by way of the endless belt; a fusing device including a pair of roller members arranged in pressing contact with each other to form a nip portion for fusing the toner image and fixing it to the recording medium, by passing the recording medium with the unfixed toner image formed thereon through the nip portion; and, a cleaning device for cleaning the surface of the endless belt, and being characterized in that the cleaning device employs the above cleaning device.

According to the first aspect of the present invention, since the first contact pressure around both the side edges of the endless belt is higher than the second contact pressure in the remaining part, even if the endless belt becomes unstable or irregular at both the side edges, it is possible to press the end parts of the cleaning member against the endless belt, hence uniformly clean the surface of the circulatively traveling endless belt. As a result, it is possible to prevent occurrence of cleaning failure around the side edges of the endless belt.

According to the second aspect of the present invention, since the first distance is smaller than the second distance, the side end parts of the cleaning member corresponding to the first supports can be pressed against the endless belt more strongly than the part of the cleaning member corresponding to the second support is.

According to the third and fourth aspects of the present invention, specifying the first length to be shorter than the second length makes it possible to press the first cleaning portions against the endless belt more strongly than the second cleaning portion.

According to the fifth aspect of the present invention, even if the endless belt becomes unstable or irregular at both the side edges, the side end part of the cleaning member corresponding to the first supports can be pressed against the endless belt more strongly than the cleaning member corresponding to the second support is. Accordingly, it is possible to uniformly clean the surface of the circulatively traveling endless belt and prevent occurrence of cleaning failure around the side edges of the endless belt. As a result, it is possible to constantly keep the endless belt as an intermediate transfer medium clean, hence provide an image forming apparatus that can stably produce high quality images.

### BRIEF DESCRIPTION OF THE DRAWINGS

FIG. 1 is an illustrative view showing one exemplary configuration of a conventional intermediate transfer device;

FIG. 2 is an illustrative view showing a state where part of the intermediate transfer belt is flexed in a conventional intermediate transfer device;

FIG. 3 is an illustrative view showing an overall configuration of an image forming apparatus in which a cleaning device according to the embodiment of the present invention is adopted;

FIG. 4 is an overall view showing a configuration of an intermediate transfer device as a part of the image forming apparatus;

FIG. 5 is an illustrative view in the direction of the arrow A in FIG. 4;

FIG. 6 is a perspective view showing the configuration of a cleaning blade and a blade holder that constitute an intermediate transfer belt cleaning unit according to the present embodiment;

FIG. 7 is a table showing the relationship between the protrusion distance of the cleaning blade projected from the blade holder, line pressure and cleaning performance; and,

FIG. 8 is a perspective view showing one configurational example of a conventional cleaning member.

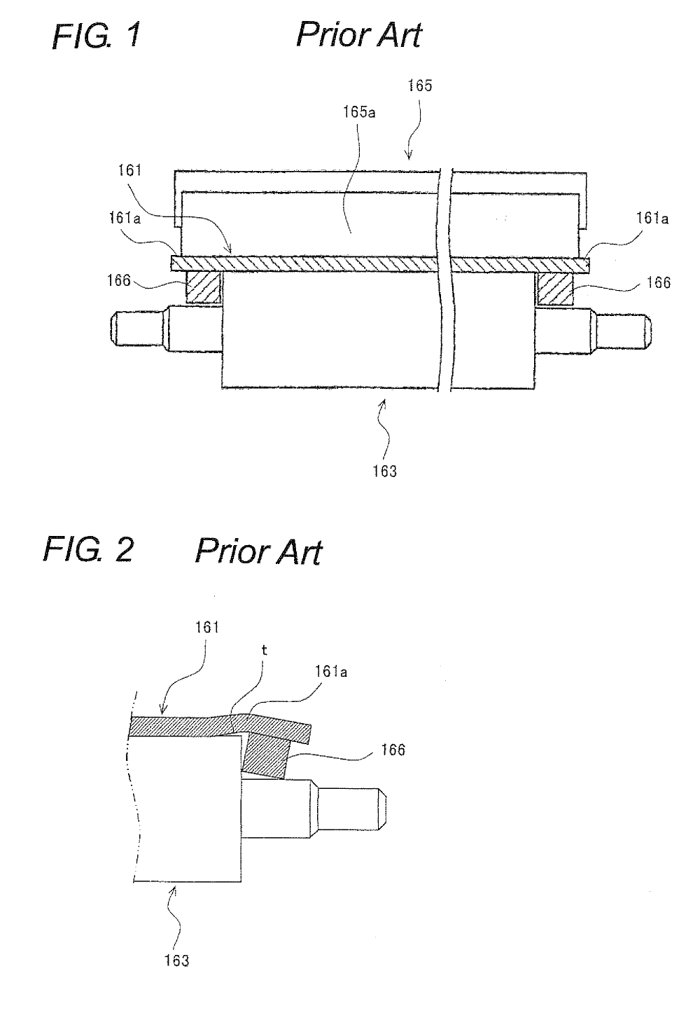

### DESCRIPTION OF THE PREFERRED EMBODIMENTS

The best embodiment of the present invention will hereinafter be described in detail with reference to the accompanying drawings.

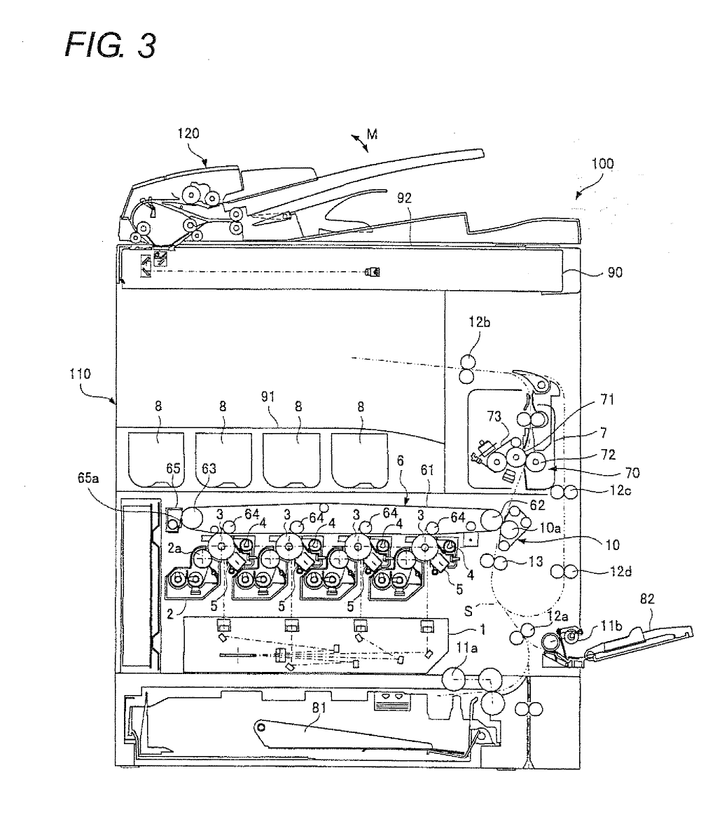

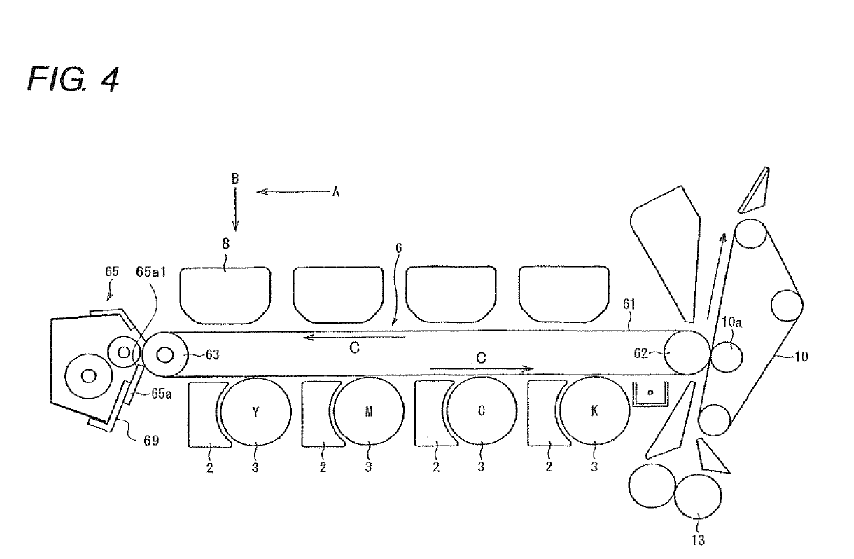

FIG. 3 is an illustrative view showing an overall configuration of an image forming apparatus in which a cleaning device according to the embodiment of the present invention is adopted. FIG. 4 is an overall view showing a configuration of an intermediate transfer device as a part of the image forming apparatus. In FIG. 4, the arrow designated at B shows a vertical direction (the direction of the gravitational force) and the arrow designated at A shows a horizontal direction.

An image forming apparatus 100 of the present embodiment includes: as shown in FIGS. 3 and 4, photoreceptor drums 3 on which electrostatic latent images are formed and toner images are formed based on the electrostatic latent images; developing units 2 including developing rollers 2a (FIG. 3) for supplying toner to photoreceptor drums 3; an intermediate transfer device (transfer device) 6 including an intermediate transfer belt (intermediate transfer medium) 61 for temporarily receiving toner images formed on photoreceptor drums 3 and transferring the toner image to a sheet (recording medium) through intermediate transfer belt 61; a fusing device (fusing rollers) 7 including a pair of roller members for fusing the toner image and fixing it to the sheet by passing the sheet with an unfixed toner image formed thereon through the nip where the roller members are put in press-contact with each other; and an intermediate transfer belt cleaning unit (cleaning device) 65 for cleaning the surface of intermediate transfer belt 61, and produces printed images by transferring the toner images formed on the surfaces of photoreceptor drums 3 based on electrophotography to sheets.

To begin with, the overall configuration of image forming apparatus 100 according to the present embodiment will be described.

As shown in FIG. 3, image forming apparatus 100 forms a multi-colored and monochrome image on a predetermined sheet (e.g., recording paper) in accordance with image data transmitted from an external device, and is mainly composed of a main apparatus body 110 and an automatic document processor 120.

Main apparatus body 110 includes: an exposure unit 1; developing units 2, photoreceptor drums 3, cleaner units 4, chargers 5, an intermediate transfer device (transfer device) 6, a fusing unit 7, a paper feed cassette 81 and a paper output tray 91.

Arranged on top of an image reader 90 in the upper part 10, of main apparatus body 110 is a document table 92 made of a transparent glass plate on which a document is placed. On the top of document table 92, automatic document processor 120 is mounted.

Automatic document processor 120 automatically feeds documents onto document table 92.

This automatic document processor 120 is constructed so as to be pivotable in the directions of bidirectional arrow M so that a document can be manually placed by opening the top of document table 92.

The image data handled in image forming apparatus 100 is data for color images of four colors, i.e., black (K), cyan (C), magenta (M) and yellow (Y).

Accordingly, four developing units 2, four photoreceptor drums 3, four chargers 5, four cleaner units 4 are provided to produce four electrostatic latent images corresponding to black, cyan, magenta and yellow. That is, four imaging stations are constructed thereby.

Exposure unit 1 is an image writing device which illuminates electrified photoreceptor drums 3 with light in accordance with image data input from without or image data captured from an original to form electrostatic latent images corresponding to the image data on the surfaces of photoreceptor drums 3, and is constructed as a laser scanning unit (LSU) having a laser emitter, reflection mirrors, etc. in this exposure unit 1, a polygon mirror for scanning a laser beam, optical elements such as lenses and mirrors for leading the laser beam reflected by the polygon mirror to photoreceptor drums 3 and others are laid out.

As exposure unit 1, other methods using an array of light emitting elements such as an EL or LED writing head, for example may be used instead.

The thus constructed exposure unit 1 has the function of illuminating each of the electrified photoreceptor drums 3 with light in accordance with the input image data to form an electrostatic latent image corresponding to the image data on the surface of each photoreceptor drum 3.

Developing unit 2 visualizes the electrostatic latent images formed on photoreceptor drums 3 with four color (Y, M, C and K) toners.

Photoreceptor drums 3 each have a cylindrical form and are disposed over exposure unit 1. The surface of each photoreceptor drum 3 is cleaned by cleaner unit 4 and then uniformly electrified by charger 5.

Cleaner unit 4 removes and collects the toner left over on the photoreceptor drum 3 surface after development and image transfer.

Charger 5 is the charging portion for uniformly electrifying the photoreceptor drum 3 surface at a predetermined potential. Other than the corona-discharge type chargers shown in FIG. 3, contact type chargers, i.e., roller type or brush type charger may also be used.

Intermediate transfer device 6 arranged over photoreceptor drums 3 is comprised of an intermediate transfer belt (intermediate transfer element) 61, an intermediate transfer belt drive roller 62, an intermediate transfer belt driven roller 63, four intermediate transfer rollers 64 corresponding to four YMCK colors and an intermediate transfer belt cleaning unit 65.

Intermediate transfer belt drive roller 62, intermediate transfer belt driven roller 63 and intermediate transfer rollers 64 are arranged so as to support and tension intermediate transfer belt 61 and circulatively drive the belt.

Intermediate transfer belt 61 is an endless film of about 100 μm to 150 μm thick and is arranged so as to contact with each photoreceptor drum 3. The toner images of different colors formed on photoreceptor drums 3 are sequentially transferred in layers to intermediate transfer belt 61, forming a color toner image (multi-color toner image) on intermediate transfer belt 61.

Transfer of toner images from photoreceptor drums 3 to intermediate transfer belt 61 are performed by intermediate transfer rollers 64 that are in contact with the rear side of intermediate transfer belt 61.

Each intermediate transfer roller 64 is adapted to apply a transfer bias to intermediate transfer belt 61 so as to transfer the toner image on photoreceptor drum 3 onto intermediate transfer belt 61. Detailedly, a high-voltage transfer bias (high voltage of a polarity (+) opposite to the polarity (−) of the static charge on the toner) is applied to intermediate transfer roller 64 in order to transfer the toner image.

Intermediate transfer roller 64 is a roller that is formed of a base shaft made of metal (e.g., stainless steel) having a diameter of 8 to 10 mm and a conductive elastic material (e.g., EPDM, foamed urethane or the like) coated on the shaft surface. This conductive elastic material enables uniform application of a high voltage to intermediate transfer belt 61. Though the transfer electrodes in the form of rollers are used in the present embodiment, brushes and the like can also be used instead of intermediate transfer rollers 64.

The visualized toner images of colors on different photoreceptor drums 3 are laid over one to the next on intermediate transfer belt 61. The thus laminated toner image as the image information is conveyed as intermediate transfer belt 61 moves, to the predetermined position (the secondary transfer station) where the sheet being conveyed comes into contact with intermediate transfer belt 61 and is transferred to the sheet by a secondary transfer belt 10 arranged at this secondary transfer station.

In this process, intermediate transfer belt 61 and secondary transfer belt 10 are pressed against each other forming a predetermined nip while a secondary transfer bias for transferring the toner image to the paper is applied to secondary transfer belt 10. This secondary transfer bias is a high voltage of a polarity (+) opposite to the polarity (−) of the static charge on the toner.

Further, in order to obtain the aforementioned predetermined nip constantly, either a transfer roller 10a that is arranged so as to press the rear side of secondary transfer belt 10 in the secondary transfer station or intermediate transfer belt drive roller 62 that is arranged so as to press the rear side of intermediate transfer belt 61 in the secondary transfer station is formed of a hard material (metal or the like) while the other is formed of a soft material such as an elastic roller or the like (elastic rubber roller, foamed resin roller etc.).

Since, in the aforementioned transfer stage, the toner adhering to intermediate transfer belt 61 as the belt comes in contact with photoreceptor drums 3, or the toner which has not been transferred by secondary transfer belt 10 to the sheet and remains on intermediate transfer belt 61, would cause color contamination of toners in the toner image formed at the next operation, the residual toner is adapted to be removed and collected by intermediate transfer belt cleaning unit 65.

Intermediate transfer belt cleaning unit 65 is arranged at a position, along the path in which intermediate transfer belt 61 is conveyed, downstream of transfer roller 10a and upstream of photoreceptor drums 3 with respect to the intermediate transfer belt's direction of movement.

Intermediate transfer belt cleaning unit 65 includes a cleaning blade 65a as a cleaning member that comes in contact with intermediate transfer belt 61 and cleans the surface of intermediate transfer belt 61. Intermediate transfer belt 61 is supported from its interior side by intermediate transfer belt driven roller 63, at the portion where this cleaning blade 65a comes into contact with the belt.

Paper feed cassette 81 is a tray for stacking sheets to be used for image forming and is arranged under exposure unit 1 of main apparatus body 110. Also, a manual paper feed cassette 82 that permits sheets to be supplied from without is arranged outside main apparatus body 110.

This manual paper feed cassette 82 can also hold a plurality of sheets to be used for image forming. Arranged in the upper part of main apparatus body 110 is a paper output tray 91 which collects printed sheets facedown.

Arranged under paper output tray 91 are toner cartridges 8 for supplying color toners to corresponding developing units 2.

Main apparatus body 110 further includes a paper feed path S that extends approximately vertically to convey the sheet from paper feed cassette 81 or manual paper feed cassette 82 to paper output tray 91 by way of transfer roller 10a and fusing unit 7. Arranged along paper feed path S from paper feed cassette 81 or manual paper feed cassette 82 to paper output tray 91 are pickup rollers 11a and 11b, a plurality of feed rollers 12a to 12d, a registration roller 13, transfer roller 10a, fusing unit 7 and the like.

Feed rollers 12a to 12d are small rollers for promoting and supporting conveyance of sheets and are arranged along paper feed path S.

Pickup roller 11a is arranged near the end of paper feed cassette 81 so as to pick up one sheet at a time from paper feed cassette 81 and deliver it to paper feed path S.

Pickup roller 11b is arranged near the end of manual paper feed cassette 82 so as to pick up one sheet at a time from manual paper feed cassette 82 and deliver it to paper feed path S.

Registration roller 13 temporarily suspends the sheet that is conveyed along paper feed path S. This roller has the function of delivering the sheet toward transfer roller 10a at such a timing that the front end of the paper will meet the front end of the image area on photoreceptor drums 3 (intermediate transfer belt 61).

Fusing unit 7 includes a pair of fusing rollers, namely a heat roller 71 and a pressing roller 72. Heat roller 71 and pressing roller 72 are arranged so as to rotate and convey the sheet while nipping it therebetween.

Heat roller 71 and pressing roller 72 are arranged opposing each other and forming a fusing nip portion at the contact point therebetween.

The temperature of heat roller 71 is controlled and set at a predetermined temperature by means of an unillustrated controller. This controller performs temperature control so that the surface temperature of heat roller 71 falls within the range of 160 to 200 deg.C., based on the detected signal from an unillustrated temperature sensor (non-contact type thermistor) that is disposed near the heat roller 71 surface to detect the temperature of heat roller 71.

Further, heat roller 71 has the function of heating and pressing the toner to the sheet in cooperation with pressing roller 72, so as to thermally fix the multi-color toner image transferred on the sheet to the sheet by fusing, mixing and pressing it. The fusing unit further includes an external heating belt 73 for fixing heat roller 71 from without as shown in FIG. 3.

Similarly to heat roller 71, pressing roller 72 also is composed of a cylindrical metal core and an elastic layer formed on the peripheral surface of the core. This pressing roller is adapted to abut heat roller 71 with a predetermined pressure.

Next, the sheet feed path in image forming apparatus 100 will be described.

As shown in FIG. 3, image forming apparatus 100 has paper feed cassette 81 for storing sheets beforehand and manual paper feed cassette 82. In order to deliver sheets from these paper feed cassettes 81 and 82, pickup rollers 11a and 11b are arranged so as to lead one sheet at a time to paper feed path S.

The sheet delivered from paper feed cassettes 81 or 82 is conveyed by feed rollers 12a on paper feed path S to registration roller 13, by which the sheet is released toward transfer roller 10a at such a timing that the front end of the sheet meets the front end of the image information on intermediate transfer belt 61 so that the image information is transferred to the sheet. Thereafter, the sheet passes through fusing unit 7, whereby the unfixed toner on the sheet is fused by heat and fixed. Then the sheet is discharged through feed rollers 12b onto paper output tray 91.

The paper feed path described above is that of the sheet for a one-sided printing request.

On the other hand, when a duplex printing request is given, the sheet with its one side printed passes through fusing unit 7 and is held at its rear end by the last feed rollers 12b, then the feed rollers 12b rotate in reverse so as to lead the sheet toward feed rollers 12c and 12d. Thereafter, the sheet passes through registration roller 13 and is printed on its rear side and discharged onto paper output tray 91.

Next, the configuration of intermediate transfer device 6 that characterizes the present embodiment will be described in detail with reference to the drawings.

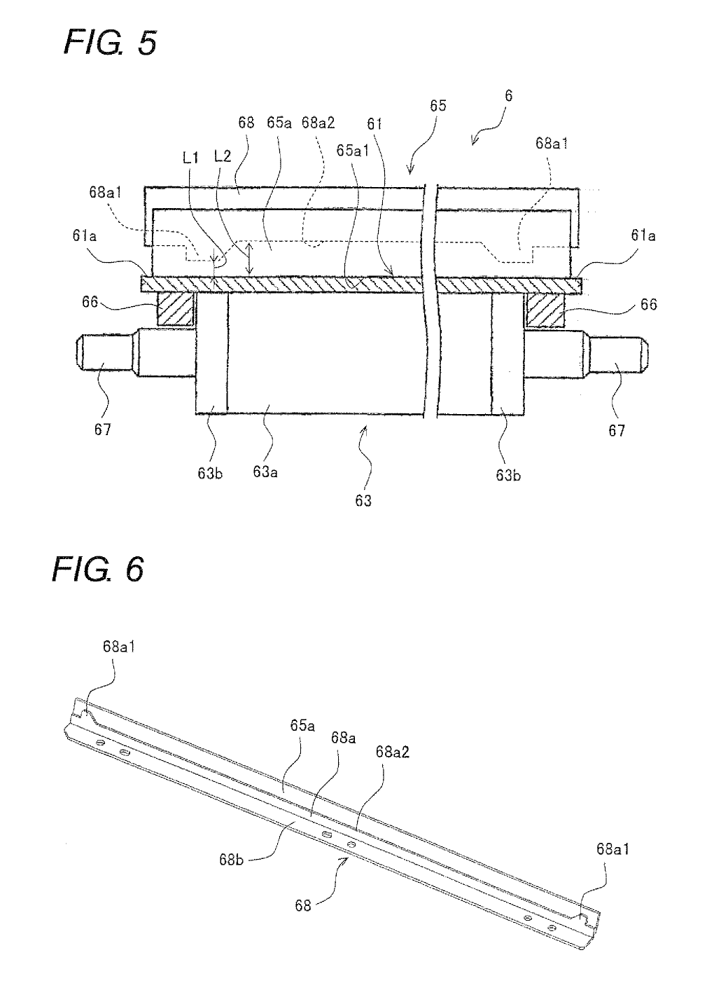

FIG. 5 is an illustrative view showing a configuration of the intermediate transfer device according to the present embodiment, viewed in the direction of the arrow A in FIG. 4.

As shown in FIGS. 4 and 5, intermediate transfer device 6 includes intermediate transfer belt driven roller (which will be referred to hereinbelow as “driven roller”) 63, a shaft 67 for rotatably supporting driven roller 63 and endless intermediate transfer belt (endless belt) 61 supported on driven roller 63.

Driven roller 63 includes a roller body 63a and a pair of covers 63b disposed at both ends of roller body 63a with respect to the axial direction of roller body 63a. Roller body 63a is a cylindrical member formed of hard material (metal or the like) while covers 63b are formed of DURACON (POM).

Intermediate transfer belt 61 is formed of a resin material having a low shrinkage ratio. Here, examples of the resin material of a low shrinkage ratio used for intermediate transfer belt 61 include PAI (polyamideimide), PI (polyimide) and PC (polycarbonate). Intermediate transfer belt drive roller 62 is a roller having approximately the same length as driven roller 63 and is arranged parallel to driven roller 63.

As shown in FIG. 5, intermediate transfer belt 61 is constructed so that its width (the dimension of the belt in the axial direction of driven roller 63) is greater than the length of driven roller 63 (the dimension in the axial direction of driven roller 63). Further, intermediate transfer belt 61 is arranged so as to be projected (beyond both the bottoms) from both end faces of driven roller 63.

When the parts of intermediate transfer belt 61 that are projected from both the end faces of driven roller 63 with respect to the axial direction of driven roller 63 are called projected areas 61a, meander restraining guides (anti-skew guides, guide members) 66 are formed on the inner peripheral side of intermediate transfer belt 61. The meandering restraining guides 66 are arranged so as to closely oppose each end of driven roller 63 with respect to its axial direction, and so as to be formed in a rib-like form extending on and around the whole inner peripheral surface of intermediate transfer belt 61. Here, meander restraining guide 66 is formed of urethane rubber (polyurethane).

According to the present embodiment having the above arrangement, since meander restraining guides 66 abut either one of end faces (bottoms, covers 63b) of driven roller 63 if intermediate transfer belt 11 meanders (or skews to one side) in intermediate transfer device 6, it is possible to prevent “belt skewing”.

It should be noted that when meander restraining guide 66 made of urethane rubber is brought into contact with metallic roller body 63a, there occurs the problem that meander restraining guide 66 is abraded. In contrast, in the present embodiment, metallic roller body 63a will not come into contact with meander restraining guides 66 but covers 63b formed of DURACON material are put in contact with meander restraining guides 66, hence it is possible to restrain meander restraining guides 66 from wearing down.

Further, as shown in FIG. 5, intermediate transfer belt cleaning unit 65 is arranged so that its cleaning blade 65a abuts the outer peripheral surface of intermediate transfer belt 61. Cleaning blade 65a scrapes off leftover toner that has not been transferred to the sheet by secondary transfer and remains on intermediate transfer belt 61, together with paper particles, dust, dirt and the like to clean the surface of intermediate transfer belt 61.

Next, the configuration of intermediate transfer belt cleaning unit 65 that characterizes the present embodiment will be described in detail with reference to the drawings.

FIG. 6 is a perspective view showing the configuration of a cleaning blade and a blade holder that constitute the intermediate transfer belt cleaning unit according to the present embodiment.

Intermediate transfer belt cleaning unit 65 includes, as shown in FIGS. 5 and 6, cleaning blade (cleaning member) 65a for frictionally abutting the surface of intermediate transfer belt 61 and a blade holder (holding member) 68 for supporting cleaning blade 65a, and cleans the surface of intermediate transfer belt 6 by means of cleaning blade 65a.

Cleaning blade 65a is arranged so that its contact pressure against intermediate transfer belt 61 across the width of intermediate transfer belt 61 becomes greater around both the side edges of intermediate transfer belt 61 than in the other part.

More specifically, as shown in FIG. 5, cleaning blade 65a has a laterally long rectangular shape along the width of intermediate transfer belt 61 so as to abut the intermediate transfer belt 61 surface over the range across approximately the full width of intermediate transfer belt 61 beyond the axial length of driven roller 63.

Blade holder 68 is comprised of, as shown in FIG. 6, a blade attachment portion 68a to which cleaning blade 65a is attached and a body-attached fixture 68b for attachment to the main part of intermediate transfer belt cleaning unit 65. Specifically, blade holder 68 holds cleaning blade 65a along its one longitudinal side over its full length by blade attachment portion 68a.

Blade attachment portion 68a has a pair of blade end supports (first supports) 68a1 for supporting the longitudinal end parts of cleaning blade 65a and a second support (second support) 68a2 for supporting the remaining part other than the blade end supports 68a1 (including the center portion between blade end supports 68a1 at both ends). That is, cleaning blade 65a has the first cleaning portions supported by blade end supports 68a1 and the second cleaning portion supported by support 68a2.

Blade end supports 68a1 are formed so as to be projected from second support 68a2. That is, with blade holder 68 attached to the main part of intermediate transfer belt cleaning unit 65, blade end supports 68a1 are disposed closer to the intermediate transfer belt 61 surface than second support 68a2 is. In other words, blade end supports 68a1 are formed longer toward intermediate transfer belt 61 than second support 68a2 as shown in FIG. 5. More explicitly, the first distance between blade end support 68a1 and intermediate transfer belt 61 is shorter than the second distance between second support 68a2 and intermediate transfer belt 61.

As cleaning blade 65a is attached to the thus constructed blade holder 68, as shown in FIG. 5 the first length of cleaning blade 65a (first cleaning portion) that is projected from blade end support 68a1 toward intermediate transfer belt 61 (the first direction that is perpendicular to the width direction of intermediate transfer belt 61), or the first length (first protrusion distance) L1 that is not laid over blade end support 68a1 is shorter than the second length of cleaning blade 65a (second cleaning portion) that is projected from second support 68a2, or the second length (second protrusion distance) L2 that is not laid over blade end support 68a2.

Next, the operation of cleaning intermediate transfer belt 61 by intermediate transfer belt cleaning unit 65 of the present invention will be described.

In cleaning intermediate transfer belt 61 by intermediate transfer belt cleaning unit 65, intermediate transfer belt 61 is circulatively conveyed while cleaning blade 65a is being abutted against the intermediate transfer belt 61 surface, as shown in FIG. 4.

Cleaning blade 65a is abutted on the intermediate transfer belt 61 surface in such a posture that its distal end 65a1 inclined toward the upstream side with respect to the intermediate transfer belt 61's direction of travel. When intermediate transfer belt 61 is conveyed in the direction of arrow C under this condition, the toner and stain residing on the intermediate transfer belt 61 surface are scraped therefrom by cleaning blade 65a and collected into intermediate transfer belt cleaning unit 65.

Cleaning blade 65a supported by blade holder 68 is abutted against intermediate transfer belt 61 with predetermined pressing force. Cleaning blade 65a presents different rigidity at the first cleaning portions around both ends thereof and in the second cleaning portion due to difference in its length with respect to the first direction. Resultantly, the pressing force of cleaning blade 65a acting on intermediate transfer belt 61 varies along the longitudinal direction. That is, the first length L1 (the first cleaning portions) at either end results in higher rigidity than the second length L2 (second cleaning portion) does. As a result, the contact pressure of cleaning blade 65a against intermediate transfer belt 61 becomes higher at both ends of the width of intermediate transfer belt 61 than the interior part therebetween.

Accordingly, even if intermediate transfer belt 61 circulatively travels while forming some gaps with driven roller 63 or becoming unstable or irregular around the side edges of intermediate transfer belt 61, use of blade holder 68 according to the present embodiment enables cleaning blade 65a to frictionally abut the intermediate transfer belt 61 surface with a higher contact pressure around its both ends than in its central portion with respect to the width, hence it is possible to uniformly clean the intermediate transfer belt 61 surface without being affected by the surface irregularities of intermediate transfer belt 61. That is, it is possible to prevent occurrence of cleaning failure.

Here, in the present embodiment, since cleaning blade 65a is laid out so as to obliquely abut itself against the surface of intermediate transfer belt 61, the edge on the free end of cleaning blade 65a will contact the intermediate transfer belt 65 surface along a line. Accordingly, the contact pressure of cleaning blade 65a against intermediate transfer belt 61 can be regarded as line pressure.

Next, verification of the cleaning effect of intermediate transfer belt cleaning unit 65 of the present embodiment on intermediate transfer belt 61 will be described.

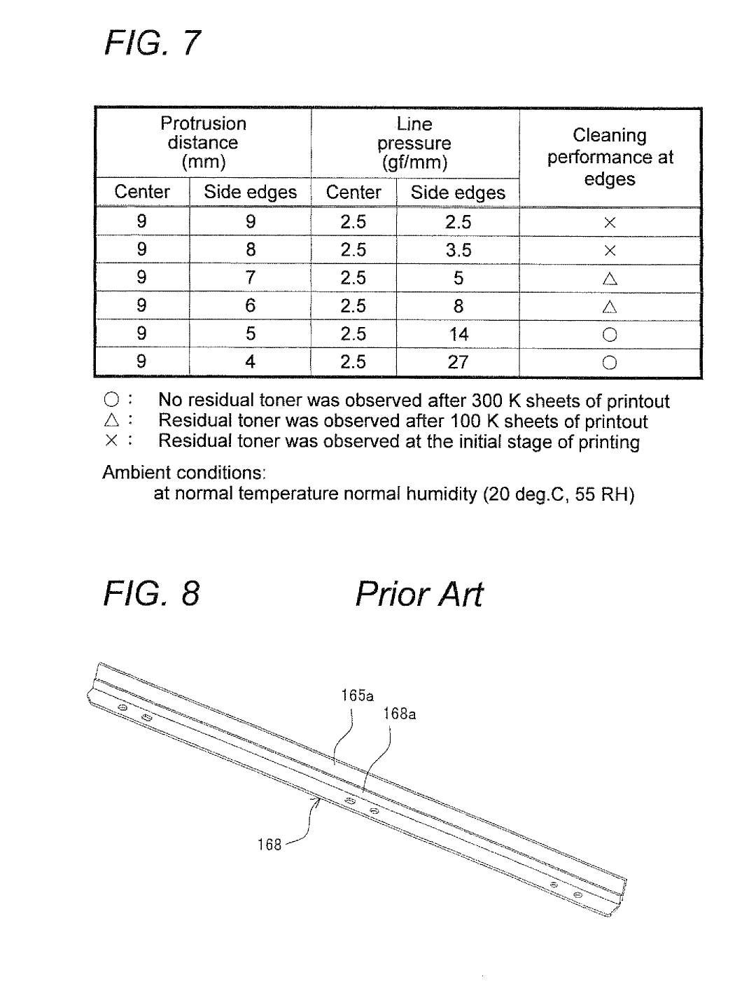

FIG. 7 is a table showing the relationship between the protrusion distance (L1, L2) of the cleaning blade projected from the blade holder, the line pressure of the cleaning blade and cleaning performance according to the intermediate transfer belt cleaning unit of the present embodiment. FIG. 8 is a perspective view showing one example of a conventional cleaning member. In this figure, 168, 165a and 168a designate a blade holder, a cleaning blade and a blade attachment portion, respectively.

The cleaning effect of intermediate transfer belt cleaning unit 65 on intermediate transfer belt 61 in the present embodiment was verified such that the line pressure of cleaning blade 65a on intermediate transfer belt 61 and the cleaning performance at the side edges of intermediate transfer belt 61 were compared by varying the protrusion distances (L1, L2) of cleaning blade 65a, projected from blade holder 68, at both ends and in the center of the width of intermediate transfer belt 61.

As shown in the table of FIG. 7, the protrusion distance of cleaning blade 65a projected from blade holder 68 was fixed at 9 mm in the center area of the width direction (the longitudinal direction of cleaning blade 65a) of intermediate transfer belt 61 (which will be merely referred to hereinbelow as “center portion”) while the distance around both ends of intermediate transfer belt 61 with respect to the width (which will be merely referred to hereinbelow as “side edges”) was reduced in decrements of 1 mm from 9 mm to 4 mm. In each of these conditions, the line pressure and cleaning performance of cleaning blade 65a were measured and evaluated.

As a result, according to the configuration of intermediate transfer belt cleaning unit 65 of the present embodiment, it turned out that the smaller the protrusion distance of cleaning blade 65a at side edges of intermediate transfer belt 61, the greater the line pressure on intermediate transfer belt 61 at the side edges and the more the cleaning performance is improved.

Specifically, as shown in the table of FIG. 7, when the protrusion distance at both side ends of cleaning blade 65a was equal to or close to the protrusion distance in the center portion, i.e., 9 mm or 8 mm, the line pressure was also equal to that in the center portion, 2.5 gf/mm or close to that, 3.5 gf/mm. However, occurrence of residual toner was observed from the start of printing, causing cleaning failure. When the protrusion distance at both side ends of cleaning blade 65a was 7 mm and 6 mm, the line pressure was 5 gf/mm and 8 gf/mm, respectively, and residual toner was observed after 100 K sheets of printing, causing cleaning failure.

On the other hand, when the protrusion distance at both side ends of cleaning blade 65a was 5 mm or 4 mm, the line pressure was several times as large as that in the center portion, specifically 14 gf/mm or 27 gf/mm, and no residual toner was observed after 300 K sheets of printing, and cleaning performance was excellent.

Here, 1 K sheets of printing indicates 1,000 sheets.

According to the present embodiment constructed as above, since, in intermediate transfer belt cleaning unit 65, a pair of blade end supports 68a1 for supporting the longitudinal end portions of cleaning blade 65a are formed in blade holder 68 for holding cleaning blade 65a so that the protrusion distance L1 of cleaning blade 65a projected from each blade end support 68a1 is shorter than the protrude distance L2 of cleaning blade 65a projected from the other part, it is possible to enhance the contact pressure (line pressure) of cleaning blade 65a in the part where blade end support 68a1 is formed, compared to the line pressure in the other part. Accordingly, even if intermediate transfer belt 61 produces some gaps with driven roller 63 or the belt becomes irregular around the side edges, it is possible to uniformly clean the intermediate transfer belt 61 surface without being affected by the surface irregularities of intermediate transfer belt 61.

As a result, according to the present embodiment, use of intermediate transfer belt cleaning unit 65 in image forming apparatus 100 makes it possible to prevent occurrence of cleaning failure of intermediate transfer belt 61 and constantly and stably output good images.

Though, in the present embodiment, the contact pressure of cleaning blade 65a against intermediate transfer belt 61 around the side edges is enhanced compared to that in the center portion by providing blade end supports 68a1 for blade holder 68, the present invention should not be limited to the above-described embodiment mode as long as the contact pressure around both side edges of intermediate transfer belt 61 is enhanced compared to that in the center portion. For example, the rigidity of the holding part of cleaning blade 65a is formed to be greater at around both the side edges of intermediate transfer belt 61 than in the other portion so as to increase the contract pressure of cleaning blade 65a around both the side edges compared to that in the center portion.

Further, though, in the present embodiment, intermediate transfer belt cleaning unit 65 for cleaning intermediate transfer belt 61 in image forming apparatus 100 was exemplified as one form of the cleaning device of the present invention, the cleaning device of the present invention should not be limited to that for cleaning intermediate transfer belt 61. For example, the present invention can be also be applied to a paper conveyor which conveys paper by means of an endless belt whilst paper particles on the belt is being cleaned by a cleaning blade, or to a belt conveyor for toner conveyance for conveying toner by means of an endless belt whilst the endless belt being cleaned by a cleaning blade.

Having described the preferred embodiment of the present invention, the present invention should not be limited to the above-described embodiment, and various changes can be made within the scope of claims. That is, any embodied mode obtained by combination of technical means disclosed by the above embodiment mode should be included in the technical art of the present invention.

For example, in the above embodiment, the present invention is applied to a color image forming apparatus (multifunctional machine, printer, etc.), however the present invention can also be applied to a monochrome image forming apparatus including a transfer belt or intermediate transfer belt.

What is claimed is:

1. A cleaning device for cleaning the surface of an endless belt by means of a cleaning member, comprising:
an endless belt supported and tensioned between a plurality of supporting rollers so as to circulate as the supporting rollers rotate;
a cleaning member being put in sliding contact with the surface of the endless belt; and,
a holding member for holding the cleaning member, characterized in that
the cleaning member has a length extending across the width of the endless belt,
the holding member is formed along the full length of the cleaning member, and
the contact pressure of the cleaning member against the endless belt along the width of the endless belt is adjusted so that the first contact pressure around both the side edges of the endless belt is higher than the second contact pressure in the remaining part.

2. A cleaning device for cleaning the surface of an endless belt by means of a cleaning member, comprising:
an endless belt supported and tensioned between a plurality of supporting rollers so as to circulate as the supporting rollers rotate;
a cleaning member being put in sliding contact with the surface of the endless belt; and,
a holding member for holding the cleaning member, characterized in that
the cleaning member has a length extending across the width of the endless belt,
the holding member has two first supports along the width of the endless belt and a second support between the two first supports, and
the first distance between the first support and the endless belt is smaller than the second distance between the second support and the endless belt.

3. The cleaning device according to claim 2, wherein, with the cleaning member attached to the holding member,
the first supports hold first cleaning portions of the cleaning member,
the second support holds a second cleaning portion of the cleaning member,
the length of the first cleaning portion in a first direction perpendicular to the width direction is the first length,
the length of the second cleaning portion in the first direction is the second length, and,
the first length is shorter than the second length.

4. The cleaning device according to claim 3, wherein the rigidity of the first cleaning portion is higher than the rigidity of the second cleaning portion.

5. An image forming apparatus which, based on electrophotography, produces a printout by forming a toner image on the surface of a photoreceptor drum and transferring the toner image onto a recording medium, comprising:
a photoreceptor drum for forming an electrostatic latent image and a toner image based on the electrostatic latent image;
a developing unit including a developing roller for supplying toner to the photoreceptor drum;
a transfer device, including an endless belt as an intermediate transfer medium for temporarily supporting the toner image formed on the photoreceptor drum, and transferring the toner image to a recording medium by way of the endless belt;
a fusing device including a pair of roller members arranged in pressing contact with each other to form a nip portion for fusing the toner image and fixing it to the recording medium, bypassing the recording medium with the unfixed toner image formed thereon through the nip portion; and,
a cleaning device for cleaning the surface of the endless belt, characterized in that
the cleaning device employs the cleaning device defined in claim 2.
